(19) United States
(12) Patent Application Publication
(10) Pub. No.: US 2002/0157188 A1
(43) Pub. Date: Oct. 31, 2002

(54) Waiter's friend corkscrew

(75) Inventor: Leonard Sannajust, Orleat (FR)

Correspondence Address: OLIFF & BERRIDGE, PLC, P.O. BOX 19928, ALEXANDRIA, VA, 22320, US

(73) Assignee: SOCIETE DE COUTELLERIE INDUSTRIELLE PUBLICITAIRE, THIERS (FR)

(21) Appl. No.: 10/117,074

(22) Filed: Apr. 8, 2002

(30) Foreign Application Priority Data
Apr. 19, 2001 (FR) 01.05529

(51) Int. Cl. B67B 7/00

(52) U.S. Cl. 7/156

(57) ABSTRACT

According to the invention, the neckstand (4) comprises, beyond its juxtaposed bearing notches (9), a dorsal extension having a length of between 0.4 and 0.6 times the distance (S) between the hinge pin (3) of the neckstand (4) and that face (9a) of the notches which rests on the rim of the container, this extension being such that it can be held and its end (4c) pressed against the neck (11) of the container by the operator's hand, operating the handle (2) with the other hand, while said face (9a) of each notch (9) forms, with respect to the web (4a) of the neckstand (4), an angle (b) of between 75° and 85°, in order that it is the end of each notch (9) that first bears on the rim of the container.

The invention relates to a waiter's-friend corkscrew.

As is known, a waiter's-friend corkscrew consists of:

a handle,

a neckstand for bearing on the neck, this neckstand being U-sectioned with a web and two flanges, being hinged at one end to one end of the handle and comprising, in each of its flanges, a notch designed to bear on the rim of the bottle,

and a helical extractor, such as a web or wire, hinged to the handle in the vicinity of the neckstand and able to fit into this handle in the storage position.

When the extractor has been engaged in the cork as far as its last turn and the notches are positioned on the rim of the neck of the container, upward movement of the end of the handle first improves the purchase of the notches on the neck and then enables the cork to be pulled vertically by the extractor. In practice, although the movement of the handle is a pivoting about its hinge point on the neckstand, which therefore means that the hinge axis of the extractor on the handle describes a circular path tending to displace it from the vertical axis of the container, the general movement is more complex. What happens is that the effort communicated to the handle tends initially to tilt the neckstand in an outward direction and then, after the handle has passed the horizontal, to move it back in, while imposing the same movement on the hinge point of the handle and the hinge axis of the corkscrew on the handle. The result is that the cork is pulled sideways, either side of its theoretical vertical path, and that it is pushed against the wall of the container with greater or lesser force. As a consequence, friction is increased and sometimes, with long corks, the cork and sometimes even the neck of the container may break.

To overcome this, and when dealing with a long cork, the operator does not engage the whole of the extractor in the cork, but extracts it about half way, and then engages the extractor the rest of the way in before resuming pulling. The danger of re-engaging the extractor is that it may split the cork and cause pieces of the cork to fall into the neck of the bottle.

The corkscrews disclosed in documents EP-A-143 475, EP-A-562 174 and EP-A-955 264 are equipped, between the handle and the neckstand, with means that modify the position of the hinge axis of these two parts with respect to the hinge axis of the extractor on the handle. This solution necessitates, while the cork is being pulled, manual adjustments which are not easy to make and which have caused this technique to be abandoned.

Another solution, disclosed in particular in documents FR-A-2 689 115 and EP-A-873 965, consists in positioning the hinge axes of the extractor and of the neckstand, respectively, on the handle, to give a circular path of the axis of the extractor on a smaller radius and providing the neckstand with an additional set of fixed or hinged bearing notches. In this solution, cork extraction necessitates stopping the upward movement of the handle, at about the halfway point, lowering it, in order to allow the second series of notches to be positioned on the rim of the container, and then resuming the upward movement of the handle. This procedure represents an improvement, but the cork is still subjected to transverse loads pressing it against the container and generating friction.

In addition, in present-day waiter's-friend corkscrews the bearing notches are formed by the two approximately perpendicular edges of a cutout in the corresponding flange of the neckstand. During extraction, the edge projecting approximately at right angles to the longitudinal axis of the neckstand bears on the rim of the container; however, the shape of this rim varies from one type of container to another. For example, on some containers the ring is flush with the rim while on others it is set back from this rim, which itself may be straight-edged or rounded. This means that a wine waiter equipped with a single corkscrew may find that, with containers offering a small surface area at the rim, the notches of the neckstand slip off the rim of the container and hamper the operation. This is especially likely to happen if the edges of the notches that press on this rim are perpendicular to the axis of the neckstand. The result is that the operator must interrupt the process in order to reposition the neckstand and try to keep it in position during the extraction and prevent it from slipping, which is difficult because the neckstand does not have much purchase.

It is an object of the present invention to provide a waiter's-friend corkscrew that solves the drawbacks set out above and that is capable of extracting a cork in one operation and with less effort.

To this end, in the corkscrew according to the invention, the neckstand comprises, beyond its two juxtaposed bearing notches, a dorsal extension having a length of between 0.4 and 0.6 times the distance between the hinge pin of the neckstand and that face of the notches which rests on the rim of the container, this extension being such that it can be held by the operator's hand and its end pressed against the neck of the container, while said face of each notch resting on the rim of the container forms, with respect to the web of the neckstand, an angle (b) of between 75° and 85°, in order that it is the end of each notch that first bears on the rim of the container.

Thus, when the extractor is engaged in the cork, the downward movement of the handle allows the neckstand to drop, by gravity, against the neck, until its two notches are bearing, by their ends only, on the rim of the container. This movement has the effect of moving the free end of the neckstand toward the container neck where it can easily be grasped by the free hand of the operator. As soon as an upward extraction force is applied to the handle, the neckstand pivots until its free end is bearing against the container, causing it to immobilize the hinge axis of the handle and thus avoid too great a transverse displacement of this handle and of the hinge pin of the extractor above the cork, thereby allowing the cork to be pulled out practically vertically with less resistance.

A clearer understanding of the invention will be gained from the following description, which refers to the attached schematic drawing showing an embodiment of the waiter's-friend corkscrew according to the invention.

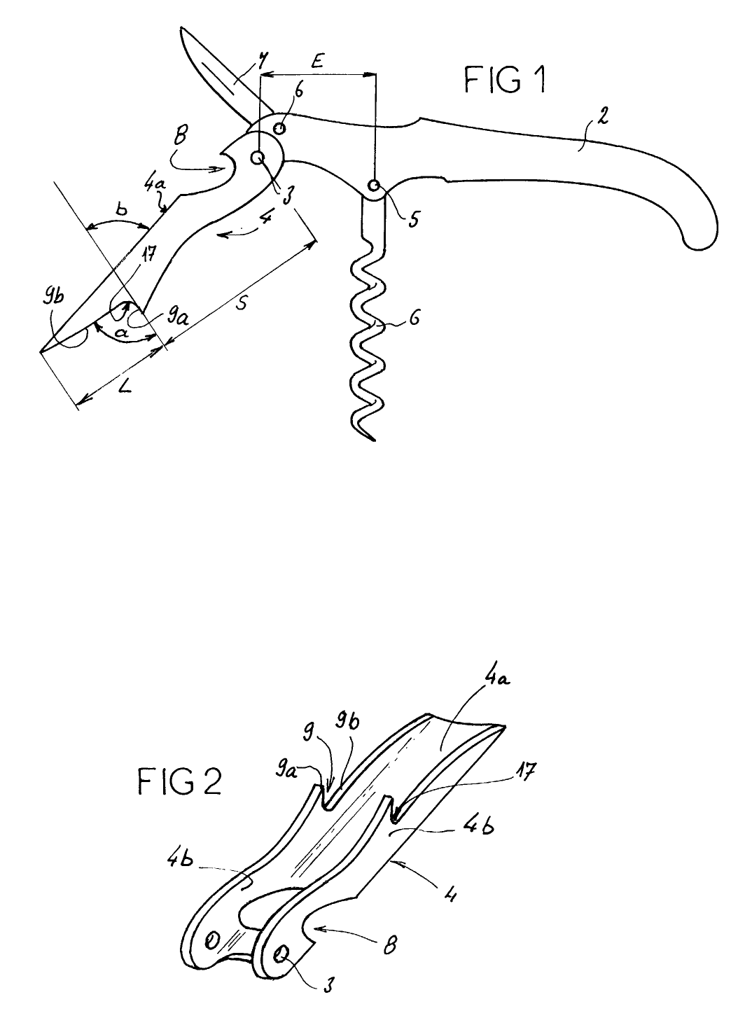

FIG. 1 is an elevation side view of the corkscrew,

FIG. 2 is a perspective view of the neckstand, shown upside down,

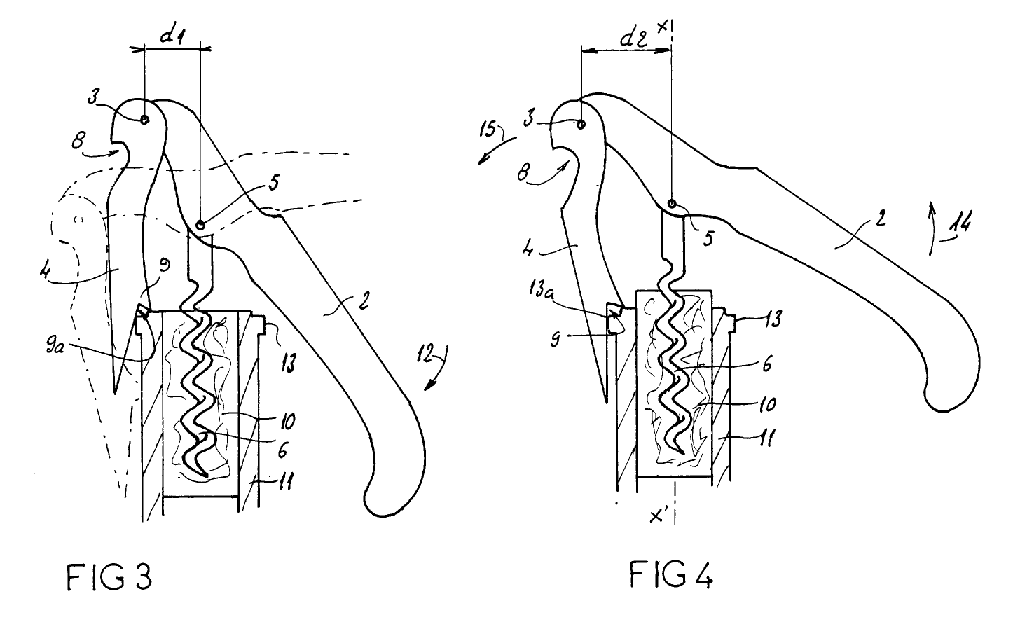

FIGS. 3-6 are side views showing different phases in the extraction of a cork,

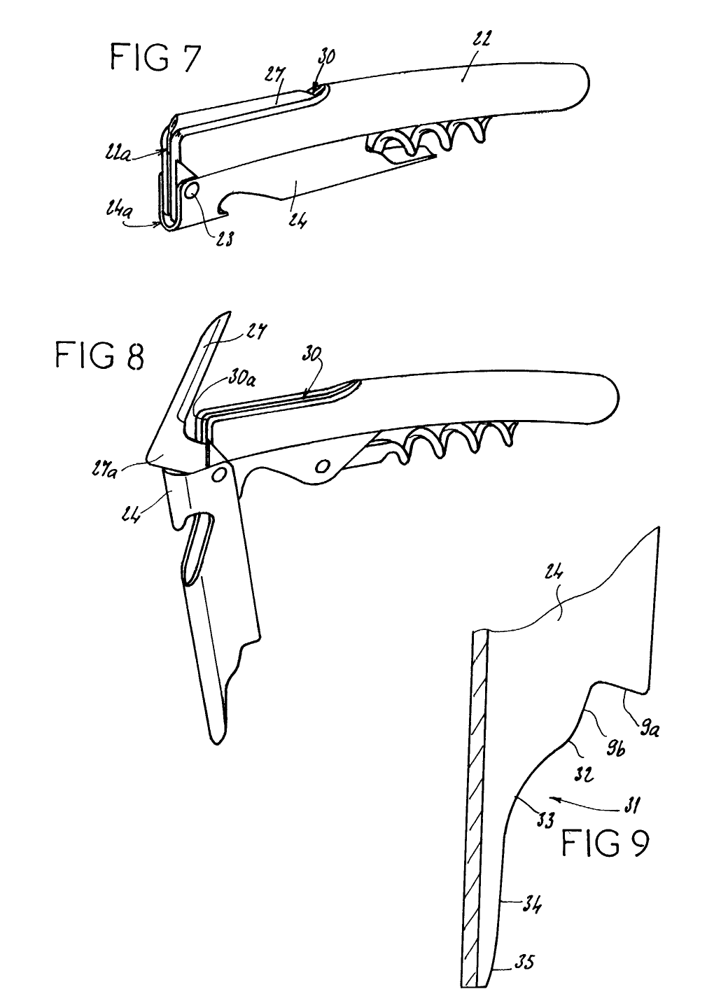

FIGS. 7 and 8 are perspective views of another embodiment of the corkscrew, and

FIG. 9 is a partial elevation view on an enlarged scale of the free end of the neckstand.

In the embodiment shown in FIGS. 1-6, the waiter's-friend corkscrew consists of a handle 2, one end of which has a hinge axis 3 for a neckstand 4. The handle 2 comprises, near the hinge axis 3, another hinge axis 5 to which is hinged one end of a helical extractor 6 which, when not in the position of use, can be folded against the handle or retracted into it. The handle also includes a hinge axis 6 for a blade 7 for cutting the foil of the cork 10. This blade can be folded into the handle when not in use.

As shown in FIG. 2, the neckstand 4 has a U-shaped cross section in which the web 4a is partly cut out to form a bottle-opener 8, and in which the two flanges 4b are each provided with a notch 9. Each notch 9 is defined by two faces, a face 9a designed to fit over the rim of the container and a face 9b designed to rest against the neck of the container. These faces are connected by a fillet 17 and form an angle a of about 90° with each other.

According to the invention and as shown in FIG. 1, the neckstand 4 comprises, beyond the notches 9, a dorsal extension extending over a distance L, which is between 0.4 and 0.6 times the distance S between the hinge pin 3 and the face 9a of each notch 9.

As an example, for a corkscrew in which the distance S is about 50 millimeters, the value of L is between 20 and 30 millimeters, and excellent results are obtained with a value of about 25 millimeters.

In accordance with another characteristic of the invention, the face 9a of each notch forms, with respect to the direction of the web 4a, an angle b of between 75 and 85°.

Thus, when the notches 9 are bearing against the rim of the bottle, as shown in FIG. 3, it is their ends which are so bearing.

Lastly, the interaxial distance E between the hinge axes 3 and 5 is about 28 millimeters, and is therefore less than in known corkscrews.

When the extractor 6 has been engaged as far as the last turn into a cork 10 closing the neck 11 of a bottle, and the handle 2 is in the position shown in chain lines in FIG. 3, the neckstand 4 is hanging against the neck, below the ring 13 of the bottle. To place the neckstand in the bearing position, the free part of the handle 2 must be tilted by pivoting it about the hinge axis 5, as shown by the arrow 12 in FIG. 3. This tilting places the ends of the notches 9 on the rim of the container and allows the operator to grasp the extension of the neckstand 4 by enclosing the neck in one hand, while with the other hand he starts the pulling movement, that is pivoting the handle 2 about the hinge axis 5, in the direction of the arrow 14 in FIG. 4.

This FIG. 4 shows that the combination of this movement with that of vertical extraction of the cork 10 generates, on the neckstand 4, a pivoting effort in the direction of the arrow 15. Due to the shape of the notches 9, and in particular of their faces 9a, 9b, the neckstand 4 pivots in an outward direction until its free end 4c contacts the neck of the container, as shown in FIG. 5, if this end was not already in contact with it, because for certain shapes of neck and ring the end 4c comes into contact with the neck as soon as the notches are resting on the rim.

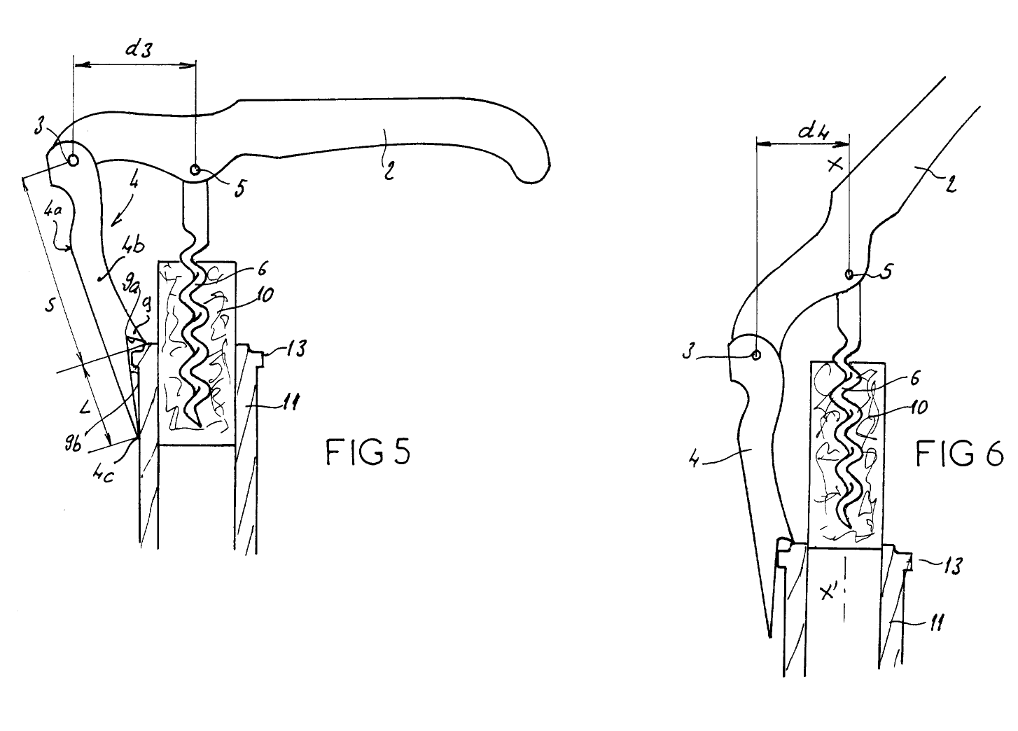

With the notches in position on the rim and the hand holding the extension in place, the neckstand 4 is immobilized and the force tending to press the cork against the wall of the neck next to this neckstand is limited. The neckstand is not however immobilized in a totally rigid way because, once the handle reaches the horizontal, shown in FIG. 5, the pressure of the end 4c of the neckstand on the hand allows the neckstand to pivot toward the container, to adjust the position of the hinge axis 3 as the distance between the hinge points 3 and 5, represented by d3 and d4 in FIGS. 5 and 6, shrinks.

Consequently, in the course of the operation of extracting the cork, the changes in position of the hinge axes 3 and 5 in a plane perpendicular to the direction of extraction, due to the circular movement of the hinge axis 5 relative to the hinge axis 3 and represented by values dI to d4 in FIGS. 3-6, are compensated for by the slight movement of the neckstand 4, so that the cork 10 moves more or less vertically and is less subject to forces tending to push it against the neck 11 and increase the friction.

These compensating movements are possible owing to:

the angular position of the faces 9a and 9b of the juxtaposed notches 9, improving the grip on the container and facilitating pivoting,

the dorsal extension of the neckstand 4, the end 4c of which bears on the neck 11,

the operator's hand which, although gripping the extension of the neckstand 4, tolerates its slight angular movements,

and the reduction of the interaxial distance E which limits the radius of the circular movement of the hinge axis 5.

The reduction of friction has the effect of reducing the effort required to open a bottle, with the corollary of reducing the fatigue of the catering staff and enabling bottles to be opened even by people with little physical strength.

Thus, to the possibility of pulling a cork in a single operation, this waiter's-friend corkscrew adds a significant reduction in the effort required, even when used with long corks, i.e. corks having a length of about 55 to 60 millimeters.

In the embodiment shown in FIGS. 7-9, the neckstand 24 has a different general shape but achieves the same effects during cork extraction. Constructed with a U-section, this neckstand comprises, near its hinge axis 23 on the handle 22, a flat end face 24a perpendicular to its general direction which lies, when in the folded position, approximately in the continuation of the straight end face 22a of the handle 22, as shown in FIG. 7.

The handle 22 is provided at this end with a housing 30 for a knife blade 27. FIG. 8 shows that this blade 27 is bent and possesses an arm 27a that is approximately perpendicular thereto, by which it is hinged to the handle. The arm 27a also folds away in a housing 30a which is recessed into the straight end face 22a of the handle.

With this arrangement and as shown in FIG. 8, when the neckstand 24 pivots from its storage position to its position of use, that is as it comes away from the handle, the web of the neckstand 24 meets the arm 27a of the blade 27 in the position of use, and forces this arm and the blade to pivot into the storage position in the handle, thus saving the operator having to perform this action.

Finally, FIG. 9, showing on an enlarged scale the end of the neckstand 24, shows that the face 9b of each of the juxtaposed notches 9 is not straight but is connected to the end 24c of the extension by a profiled edge 31 whose profile is larger than and homothetic to the envelope of the profiles of the necks and rings of the openable containers. More precisely the face 9b runs into a convex rounding 32, which runs into a concave curve 33 of larger radius and then meets the tangential straight line segment 34. The latter leads into a final rounding of large radius 35. This profile is designed so that whatever the shape and position of the ring or of the neck, the end of the neckstand 24 is always able to bear on said neck to help control the movements of this neckstand.

1. A waiter's-friend corkscrew consisting of:
a handle (2),
a neckstand (4), this neckstand being U-sectioned with a web (4a) and two flanges (4b ), being hinged at one end to one end of the handle and comprising, in each of its flanges (4b ), a notch (9) designed to bear on the rim of the container,
a helical extractor (6) hinged to the handle (2) in the vicinity of the neckstand (4) and able to fit into this handle in the storage position,
and a knife blade (7) that fits into the handle,
wherein the neckstand (4, 24) comprises, beyond its juxtaposed bearing notches (9), a dorsal extension having a length of between 0.4 and 0.6 times the distance (S) between the hinge pin (3, 23) of the neckstand (4, 24) and that face (9a) of the notches which rests on the rim of the container, this extension being such that it can be held by the operator's hand and its end (4c) pressed against the neck (11) of the container, while said face (9a) of each notch (9) forms, with respect to the web (4a) of the neckstand (4, 24), an angle (b) of between 75° and 85°, in order that it is the end of each notch (9) that first bears on the rim of the container.

2. The waiter's-friend corkscrew as claimed in claim 1, wherein the face (9b) of each of the juxtaposed notches (9) is connected to the end (24c) of the neckstand (24) by a profiled edge (31) whose profile is larger than and homothetic to the envelope of the profiles of the necks and rings of the openable containers.

3. The waiter's-friend corkscrew as claimed in claim 1, wherein the blade (27) of the knife is bent and possesses an arm (27a) that is approximately perpendicular thereto, by which it is hinged to the hinge pin (23) of the neckstand (24), this arm fitting into a housing (30a) formed in the straight end face (22a) of the handle (22), while the neckstand (24) possesses, near its hinge (23), a flat end face (24a) perpendicular to its general direction and able, when the neckstand is moved away from the handle, to come into contact with the arm (27a) of the blade (27) of the knife, to move said blade and the knife, into the storage position in the handle.
